(19) United States
(12) Patent Application Publication
(10) Pub. No.: US 2024/0406792 A1
(43) Pub. Date: Dec. 5, 2024

(54) REQUESTING QOE MEASUREMENT REPORT SIZE

(71) Applicant: Lenovo (Singapore) Pte. Ltd., New Tech Park (SG)

(72) Inventors: Hyung-Nam Choi, Ottobrunn (DE); Joachim Löhr, Wiesbaden (DE)

(21) Appl. No.: 18/694,837

(22) PCT Filed: Sep. 22, 2022
(86) PCT No.: PCT/IB2022/058981

§ 371 Date: Mar. 22, 2024

Related U.S. Application Data
(60) Provisional application No. 63/247,170, filed on Sep. 22, 2021.

(51) Int. Cl. H04W 28/02; H04W 24/02

(52) U.S. Cl. CPC H04W 28/0278; H04W 24/02

(57) ABSTRACT

Apparatuses, methods, and systems are disclosed for QoE measurement reporting control. One method includes receiving, from a communication network, a first message requesting a size of stored QoE measurement reports in an RRC buffer. The method includes determining, by the communication device, the size of the stored QoE measurement reports in response to the first message and transmitting, to the communication network, a second message including the size of stored QoE measurement reports in the RRC buffer. The method includes receiving, from the communication network, a third message including a configuration to enable resumption of QoE measurement reporting and transmitting, to the communication network, at least one fourth message including at least one QoE measurement report.

### CROSS-REFERENCE TO RELATED APPLICATIONS

This application claims priority to U.S. Provisional Patent Application No. 63/247,170 entitled “QOE MEASUREMENT REPORTING CONTROL IN NR SYSTEMS” and filed on 22 Sep. 2021 for Hyung-Nam Choi and Joachim Lohr, which application is incorporated herein by reference.

### FIELD

The subject matter disclosed herein relates generally to wireless communications and more particularly relates to Quality of Experience (“QoE”) measurement reporting control, e.g., in Third Generation Partnership Project (“3GPP”) New Radio (“NR”) systems.

### BACKGROUND

Currently in 3GPP systems, Universal Terrestrial Radio Access Network (“UTRAN,” i.e., a Third Generation (“3G”) Radio Access Technology (“RAT”)) and for evolved UTRAN (“E-UTRAN”, i.e., a Fourth Generation (“4G”) RAT), QoE Measurement Collection (“QMC”) has been specified for streaming services and Multimedia Telephony Service for IMS (“MTSI”). This feature allows the operators to collect and utilize the QoE measurement information of streaming and MTSI services to better understand the user experience and optimize their UTRAN/E-UTRAN network for the concerned services. However, QMC is currently not supported in NR. Solutions are needed for efficient control of QoE measurement reporting in an NR radio access network (“RAN”).

### BRIEF SUMMARY

Disclosed are procedures related to QoE measurement reporting control. Said procedures may be implemented by apparatus, systems, methods, or computer program products.

One method at a User Equipment (“UE”) includes receiving, from a communication network, a first message requesting a size of stored Quality of Experience (“QoE”) measurement reports in a Radio Resource Control (“RRC”) buffer. The method includes determining, by the communication device, the size of the stored QoE measurement reports in response to the first message and transmitting, to the communication network, a second message including the size of stored QoE measurement reports in the RRC buffer. The method includes receiving, from the communication network, a third message including a configuration to enable resumption of QoE measurement reporting and transmitting, to the communication network, at least one fourth message including at least one QoE measurement report.

One method at a network device includes transmitting, to a communication device, a first message to request a size of stored QoE measurement reports in an RRC buffer of the communication device and receiving, from the communication device, a second message including the size of the stored QoE measurement reports. The method includes determining, using the second message, a configuration to enable resumption of QoE measurement reporting at the communication device and transmitting, to the communication device, a third message including the configuration to enable resumption of QoE measurement reporting. The method includes receiving, from the communication device, at least one fourth message including at least one QoE measurement report.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for QoE measurement reporting control;

FIG. 2 is a block diagram illustrating one embodiment of a New Radio (“NR”) protocol stack;

FIG. 3 is a diagram illustrating one embodiment of Uplink (“UL”) AS protocol layer configuration with NR QoE measurement reporting;

FIG. 4 is a diagram illustrating one embodiment of Abstract Syntax Notation #1 (“ASN.1”) structure for an RRCBufferStatusRequest message;

FIG. 5 is a diagram illustrating one embodiment of ASN.1 structure for an RRCBufferStatusResponse message;

FIG. 6 is a diagram illustrating one embodiment of ASN.1 structure for an RRC resume indication;

FIG. 7 is a diagram illustrating one embodiment of storage of QoE reports in an RRC buffer;

FIG. 8 is a diagram illustrating one embodiment of creating and transmitting multiple QoE reports in the MeasurementReportAppLayer message;

FIG. 9 is a diagram illustrating embodiments of a first option for QoE report handling at QoE pause;

FIG. 10 is a diagram illustrating one embodiment of QoE measurement reporting with segmentation;

FIG. 11 is a diagram illustrating embodiments of a second option for QoE report handling at QoE pause;

FIG. 12 is a block diagram illustrating one embodiment of a user equipment apparatus that may be used for QoE measurement reporting control;

FIG. 13 is a block diagram illustrating one embodiment of a network apparatus that may be used for QoE measurement reporting control;

FIG. 14 is a flowchart diagram illustrating one embodiment of a first method for QoE measurement reporting control; and

FIG. 15 is a flowchart diagram illustrating one embodiment of a second method for QoE measurement reporting control.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments oflike elements.

Generally, the present disclosure describes systems, methods, and apparatuses for QoE measurement reporting control mechanisms. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

QMC is currently not supported in NR but will be specified in Rel-17 in the context of the NR QoE work item. The objectives of the work item are to specify the support for QMC in NR standalone mode, specify QoE measurement handling in RRC_INACTIVE state, specify the support for QMC and reporting continuity in intra-system intra-RAT mobility scenario for signaling based QoE, specify the support of RAN visible QoE, specify the support for per-slice QoE measurement and specify the necessary mechanism to support alignment of radio-related measurement and QoE measurement.

In contrast to UTRAN and E-UTRAN, NR QoE will be designed in a more generic and flexible fashion supporting various kinds of services such as streaming services, MTSI, Virtual Reality (“VR”), Multicast Broadcast Service (“MBS”), Extended Reality (“XR”).

The handling of QoE measurement reports (in the following shortened to “QoE reports”) is currently under discussion due to the following reasons:

In NR QoE, the UE may be configured for multiple simultaneous QoE measurements. The maximum number of simultaneous QoE measurements has not been decided yet, but candidate values are in the range 8 to 64. As consequence, the UE Application Layer may create many QoE reports during an active QMC session which then need to be transmitted to the network. Furthermore, depending on the configured service types and reporting interval, e.g., at the end of each QMC session or every 10 min for longer QMC sessions, the size of QoE reports may be mostly smaller than 8 kBytes and in rare case the size of QoE reports may exceed 8 kBytes. However, for more advanced newer service types such as VR the size of QoE reports may be about 18 kBytes with reporting every 10 min.

During RAN overload the 5G/NR Node B (“gNB”) may send a QoE pause indication to instruct the UE to temporarily stop sending QoE reports of the affected QoE measurement configurations until receiving a QoE resume indication from the gNB. During the QoE pause phase the UE Application Layer continues with QMC. That means, depending on how long the RAN overload situation may take in the network (minutes, hours or longer), the UE may create many QoE reports which need to be transmitted to the network after the RAN overload has been relieved.

In view of above reasons, solutions for an efficient control of QoE measurement reporting in NR RAN are needed for addressing the following issues:
A) Handling of QoE reports in normal operation, i.e., whether to transmit a QoE report individually or multiple QoE reports in a single MeasurementReportAppLayer message.
B) Handling of stored QoE reports when RAN overload is relieved, i.e., how to transmit the stored QoE reports in a MeasurementReportAppLayer message.
C) How to perform UL segmentation of a MeasurementReportAppLayer message if multiple QoE reports need to be transmitted and the size of the concatenated QoE reports exceed the maximum size of an RRC message of 9000 bytes.

In order to support QoE measurement reporting in NR RAN in an efficient manner, the following solutions are proposed. According to a first solution, RRC messages are introduced for requesting and transferring the size of stored QoE reports in the UE. According to a second solution, indication of QoE reporting policy is provided in a QoE resume indication. According to a third solution rules are provided for creating and transmitting QoE reports in the MeasurementReportAppLayer message.

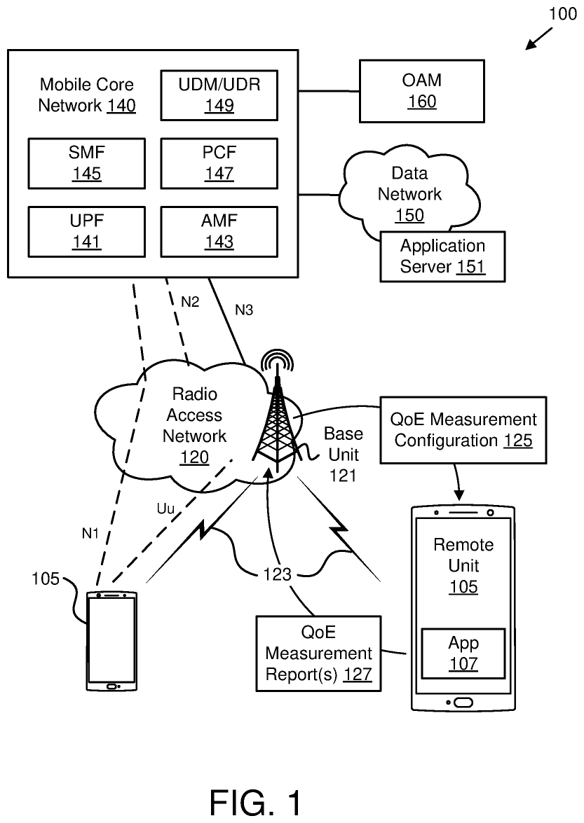

FIG. 1 depicts a wireless communication system 100 for QoE measurement reporting control, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication networks, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication (not shown in FIG. 1). Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframes, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, abase station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

To facilitate QMC, the base unit 121 transmits a QoE measurement configuration 125 to the remote unit 105. The QoE measurement configuration 125 may indicate a service type and a reporting interval. Note that the remote unit 105 may be configured with multiple simultaneous QoE measurements. Consequently, the remote unit 105 generates at least one QoE measurement report 127, in accordance with the received configuration, and transmits the QoE measurement report 127(s) to a base unit 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

The Operations, Administration and Maintenance (“OAM”) 160 is involved with the operating, administering, managing, and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM 160 may also be involved with provisioning, i.e., the setting up of the user accounts, devices, and services.

While FIG. 1 depicts components of a 5G RAN and a 5G core network, the described embodiments for QoE measurement reporting control apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems QoE measurement reporting control.

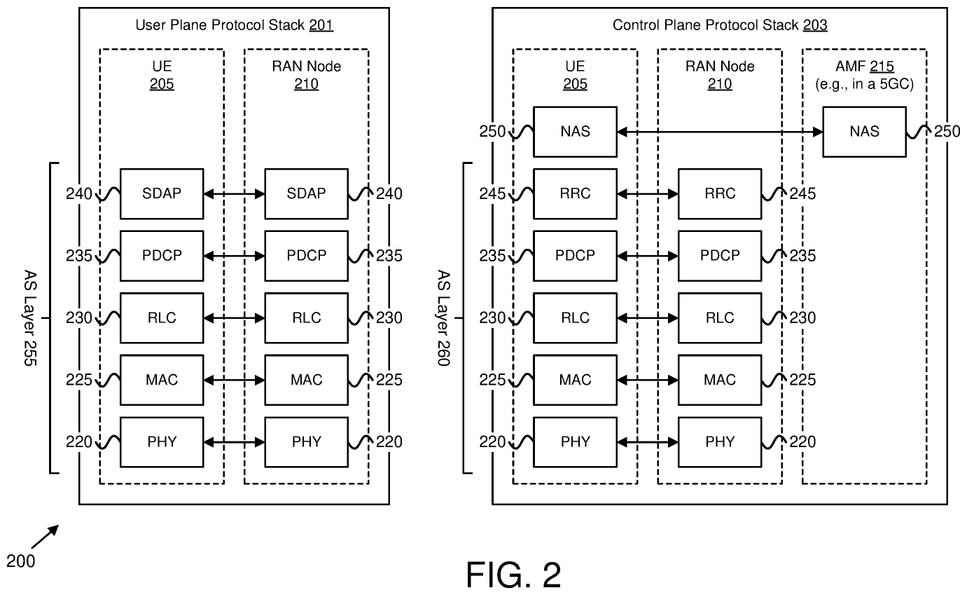

FIG. 2 depicts an NR protocol stack 200, according to embodiments of the disclosure. While FIG. 2 shows the UE 205, the RAN node 210 and an AMF 215 in a 5G core network (“5GC”), these are representatives of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

During RAN overload, the RAN node 210 may send a QoE pause indication to instruct the UE 205 to temporarily stop sending QoE reports of the affected QoE measurement configurations until receiving a QoE resume indication from the RAN node 210. During the QoE pause phase, the UE application layer continues with QMC. That means, depending on how long the RAN overload situation may take in the network (minutes, hours or longer), the UE 205 may create many QoE reports which need to be transmitted to the network after the RAN overload has been relieved. According to a first option for QoE report handling, the QoE reports are stored at the UE application layer during the QoE pause phase. According to a second option for QoE report handling, the QoE reports are stored at the UE AS layer during the QoE pause phase.

For UTRAN and E-UTRAN, QoE Measurement Collection (“QMC”) for streaming services and/or MTSI have been specified. In 3GPP specifications there are two methods defined how OAM can initiate QMC activation/deactivation: Signaling-based initiation and management-based initiation.

The signaling-based procedure is a control-plane procedure where the core network (“CN”) is involved, and the CN determines the qualified/concerned UEs 205 to which the QMC activation/deactivation configuration is to be sent. In the case of signaling-based initiation, the OAM 160 initiates QMC activation/deactivation but it is the CN that actually activates/deactivates QMC towards the RAN 120. The steps of the signaling-based procedure are as follows:
Step 0: The RAN 120 receives UE capability information from the UE AS layer (of the UE 205), amongst other whether it supports QMC or not.
Step 1: The OAM 160 is interested in receiving QoE measurements for certain services from UEs 205 which are being serviced in a PLMN and sends to CN a “Configure QoE measurement” message including QoE measurement configuration. The QoE measurement configuration may include parameters such as PLMN target, session to record of an application, service type, area scope (list of cells or list of Tracking Areas (“TAs”)), QoE reference (final destination for the QoE measurement reports to send, e.g. Trace Collection Entity (“TCE”) or Measurement Collection Entity (“MCE”)), QoE metrics of the concerned service type (including start time and duration of recording), or the like. For details see 3GPP Technical Specification (“TS”) 28.405. For instance, QoE metrics for streaming services include amongst other Average Throughput, Initial Playout Delay, Buffer Level, Play List, Device information. For details see 3GPP TS 26.247.
Step 2: In accordance with the received QoE measurement configuration from the OAM 160, the CN activates the QoE measurement configuration for a qualified UE 205 and forwards the QoE measurement configuration to the RAN 120 using an “Activate QoE measurement” message.
Step 3: The RAN 120 sends the QoE measurement configuration in a DL RRC message to the UE AS layer.
Step 4: The UE AS layer sends the received QoE measurement configuration to its application layer (“AL”) using AT (ATtention) command.
Step 5: The UE AL starts QoE measurement collection in accordance with the received QoE measurement configuration.
Step 6: If the QoE measurement collection has been completed, then the UE AL sends the collected QoE measurement results to its AS layer in a QoE measurement report using AT command.
Step 7: The UE AS layer sends the QoE measurement report in a UL RRC message to the RAN 120.
Step 8: The RAN 120 forwards the received QoE measurement report to the TCE/MCE.

The OAM 160 initiates QMC deactivation if it is not interested in receiving QoE measurements for certain services from UEs 205 anymore, e.g., because it has enough QoE information for those services. The steps of the signaling-based QMC deactivation are as follows:
Step 1: The OAM 160 sends to the CN a “Configure Deactivation” message including an indication of the concerned service.
Step 2: In accordance with the received “Configure Deactivation” message from the OAM 160, the CN sends “Deactivate QoE measurement” message to the RAN 120 with the indication for which UE 205 the concerned QoE measurement configuration should be deactivated.
Step 3: The RAN 120 sends the deactivation indication in a DL RRC message to the UE AS layer to release the concerned QoE measurement configuration.
Step 4: The UE AS layer sends the received deactivation indication to its AL using AT command. The UE AL stops the recording and reporting of the concerned QoE measurements.

In contrast, the management-based procedure is a procedure that does not involve the CN (e.g., the CN is bypassed), and the OAM 160 directly activates/deactivates a QMC configuration towards RAN. In case of management-based initiation, the RAN 120 determines the qualified UEs 205 to which the QMC activation/deactivation configuration is to be sent. The steps of the signaling-based procedure are as follows:
Step 0: The RAN 120 receives UE capability information from UE 205, amongst other whether it supports QMC or not.
Step 1: The OAM 160 is interested in receiving QoE measurements for certain services from UEs 205 which are being serviced in a PLMN in a certain area and activates the QoE measurement configuration targeting an area and forwards the QoE measurement configuration to RAN using an “Activate QoE measurement” message.
Step 2: The RAN 120 determines the qualified UEs 205 to send the QoE measurement configuration in the targeted area and sends the QoE measurement configuration in a DL RRC message to the qualified UE(s) AS layer.
Step 3: The UE AS layer sends the received QoE measurement configuration to its AL using AT command.
Step 4: The UE AL starts QoE measurement collection in accordance with the received QoE measurement configuration.
Step 5: If the QoE measurement collection has been completed, then the UE AL sends the collected QoE measurement results to the UE AS layer in a QoE measurement report using AT command.
Step 6: The UE AS layer sends the QoE measurement report in a UL RRC message to the RAN 120.
Step 7: The RAN 120 forwards the received QoE measurement report to the TCE/MCE.

The OAM 160 initiates QMC deactivation if it is not interested in receiving QoE measurements for certain services from UEs anymore, e.g., because it has enough QoE information for those services. The steps of the management-based QMC deactivation are as follows:
Step 1: The OAM 160 sends “Deactivate QoE measurement” message to the RAN 120 with the indication which QoE measurement configuration should be deactivated.
Step 2: The RAN 120 sends the deactivation indication in a DL RRC message to the concerned UE(s) AS layer to release the concerned QoE measurement configuration.
Step 3: The UE AS layer sends the received deactivation indication to its AL using AT command. The UE AL stops the recording and reporting of the concerned QoE measurements.

Regarding QoE measurement configuration and reporting in the AS layer, for E-UTRAN (aka LTE) in Rel-15 for QoE measurement configuration and reporting is transparent to the AS layer, as described in 3GPP TS 36.331. The QoE measurement configuration from OAM is included in the container “measConfigAppLayerContainer-r15” in the DL RRCConnectionReconfiguration message. The maximum size of a QoE measurement configuration can be 1000 bytes.

For transferring the QoE measurement report, the UE 205 uses Signaling Radio Bearer (“SRB”) SRB4 and the UL RRC MeasurementReportAppLayer message. The QoE measurement report is included in the container “measReportAppLayerContainer-r15”. The maximum size of a QoE measurement report can be 8000 bytes. An event-triggered QoE reporting is supported only, i.e., whenever the UE AS layer receives a QoE report from the UE application layer, it transfers the QoE report to the E-UTRAN.

The QoE measurement configuration and reporting are supported in RRC_CONNECTED state only. The RRC signaling allows the LTE eNB to either setup and release a single QoE measurement configuration for a UE 205 at a time, i.e., a setup and release of multiple QoE measurement configurations is not supported. Furthermore, a temporary pause or resume of QoE measurement configurations is not supported either.

Regarding measurement collection for connected mode mobility, a UE (e.g., the UE 205) in RRC_CONNECTED state will be configured by network to measure and report neighboring cells in order to properly perform handover depending on, e.g., the mobility of the UE or network load (in source cell and candidate target cells, e.g., reported via Xn/X2 interface). An exemplary message flow of measurement configuration and reporting for connected mode mobility is described below. The message flow involves the UE 205 and the RAN node 210.

At Step 1, the UE 205 receives the measurement and reporting configuration (e.g., in parameter measConfig) from the RAN node 210 either via the RRCReconfiguration or RRCResume message. According to NR Rel-16 specification 3GPP TS 38.331, the measurement and reporting configuration includes amongst other the following information: A) Measurement configuration, which defines what to measure (i.e., RAT, and/or carrier frequency, and/or list of cells, etc.); and B) Reporting configuration, which defines when and how measurements shall be reported (e.g., periodical, or event-triggered). In the case of periodical reporting, a defined report interval triggers the reporting. In case of event-triggered reporting, a certain measurement result triggers the reporting.

At Step 2, in accordance with the measurement and reporting configuration received from the RAN node 210, the UE 205 measures neighboring cells and reports the cells which fulfill the measurement criteria, e.g., measurement object, thresholds, periodical or event-based triggering, cells to measure, etc.

At Step 3, the UE 205 reports the measured results to the RAN node 210 via the MeasurementReport message.

At Step 4, the RAN node 210 evaluates the reported measurements from the UE 205 and decides on whether to perform handover—or not—depending on, e.g., the mobility of the UE 205 or network load.

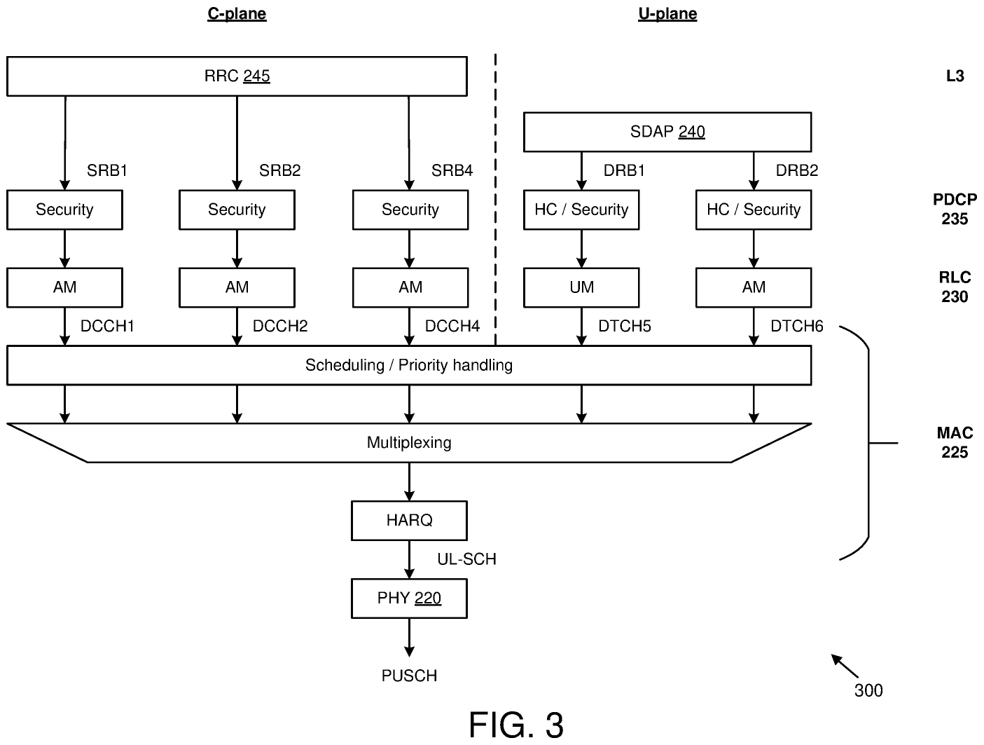

FIG. 3 depicts one configuration of a UL AS protocol layer 300 with NR QoE measurement reporting. The UL AS protocol layer 300 may be one embodiment of the uplink aspects of the AS layer 255 and AS layer 260 in the UE 205, described above with reference to FIG. 2. In the control plane, three SRBs are configured: SRB1 for RRC messages, SRB2 for NAS messages, and SRB4 for the MeasurementReportAppLayer message used for sending application layer measurement reports for streaming and MTSI services. In the user plane, two DRBs are configured: DRB1 for carrying data of an MTSI service and DRB2 for carrying data of IP Multimedia Subsystem (“IMS”) signaling.

In MAC sublayer 225, the UE 205 creates a MAC PDU (e.g., for the non-Multiple-Input Multiple-Output (“MIMO”) case) to be transmitted on PUSCH in the PHY layer 220. A MAC PDU refers to a transport block (“TB”) and contains UL data from the different logical channels. The UE 205 performs the scheduling and priority handling of the UL data from the different logical channels in accordance with the configuration received from the network. See 3GPP TS 38.331 and 3GPP TS 38.321. The network controls the scheduling and priority handling of UL data by the following main parameters:
priority in the range 1 to 16, i.e., value 1 is highest priority and value 16 is lowest priority. The parameter is set for each configured logical channel.
prioritisedBitRate which sets the Prioritized Bit Rate (“PBR”) in the value range {0 kBps, 8 kBps, 16 kBps, 32 kBps, 64 kBps, 128 kBps, 256 kBps, 512 kBps, 1024 kBps, 2048 kBps, 4096 kBps, 8192 kBps, 16384 kBps, 32768 kBps, 65536 kBps, infinity}. For SRBs, the PBR is set to infinity. The PBR corresponds to a guaranteed minimum bit rate.
bucketSizeDuration which sets the Bucket Size Duration (“BSD”) in the value range {5 ms, 10 ms, 20 ms, 50 ms, 100 ms, 150 ms, 300 ms, 500 ms, 1000 ms}.

The above parameters ensure that the UE 205 transmits the UL data according to the Quality of Service (“QoS”) of each configured radio bearer and the allocated radio resources. On the other hand, they ensure that potential starvation of UL data from low-priority radio bearers is avoided.

Exemplary configuration for MAC scheduling and priority handling are described in Table 1, below:

TABLE 1

| | Logical Channel | | Prioritized | | Bucket Size | |
|---|---|---|---|---|---|---|
| RB | Identity | Priority | Bit Rate | | Duration | |
| SRB1 | 1 | 1 | Infinity | | 1000 | ms |
| SRB2 | 2 | 2 | Infinity | | 1000 | ms |
| SRB4 | 4 | 4 | Infinity | | 1000 | ms |
| DRB1 | 5 | 6 | 8 | kBps | 100 | ms |
| DRB2 | 6 | 7 | 16 | kBps | 100 | ms |

The solutions described herein deal with supporting QoE measurement reporting in NR RAN in an efficient manner. According to a first solution, RRC messages are introduced for requesting and transferring the size of stored QoE reports in the UE 205. According to a second solution, indication of QoE reporting policy is provided in a QoE resume indication. According to a third solution rules are provided for creating and transmitting QoE reports in the MeasurementReportAppLayer message.

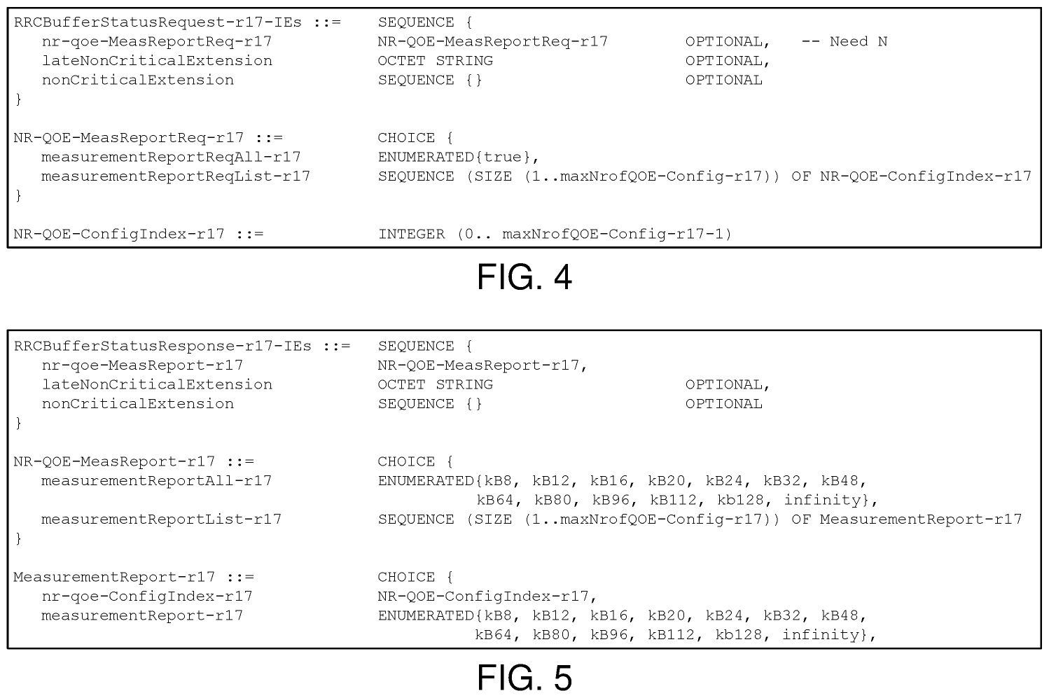

According to embodiments of the first solution, new RRC messages are introduced for requesting and transferring the size of stored QoE reports in the UE 205. FIGS. 4 and 5 depict embodiments of the ASN.1 structure for the following new RRC messages:

FIG. 4 depicts an example of an RRCBufferStatusRequest message containing the parameter “nr-qoe-MeasReportReq-r17” to request the size of stored QoE reports in the UE 205. With the parameter “measurementReportReqAll-r17” the network requests the size of all stored QoE reports. With the parameter “measurementReportReqList-r17” the network requests the size of stored QoE reports for a list of configured QoE measurements given by “NR-QOE-ConfigIndex-r17”.

FIG. 5 depicts an example of an RRCBufferStatusResponse message containing the parameter “nr-qoe-MeasReport-r17” to transfer the size of stored QoE reports in the UE 205. With the parameter “measurementReportAll-r17” the UE 205 transfers the size of all stored QoE reports. In FIG. 5, an exemplary value range for this parameter is shown. The value “kB8” means that the size of all stored QoE reports is equal to or lower than 8 kBytes, the value “kB12” means that the size of all stored QoE reports is equal to or lower than 12 kBytes and so on. The value “infinity” means that the size of all stored QoE reports is larger than 128 kBytes.

With the parameter “measurementReportList-r17” the UE 205 transfers the size of stored QoE reports for a list of configured QoE measurements given by “nr-qoe-ConfigIndex-r17”. In FIG. 5, an exemplary value range for this parameter is shown. Except of value “infinity” each value given by parameter measurementReport-r17 means that the size of the stored QoE reports for the configured QoE measurement is equal to or lower than the signaled value. The value “infinity” means that the size of the stored QoE reports for the configured QoE measurement is larger than 128 kBytes.

Alternatively, the content of the new RRC messages may be carried on existing RRC messages, i.e., the content of RRCBufferStatusRequest may be carried on, e.g., UEInformationRequest or RRCReconfiguration, and the content of RRCBufferStatusResponse may be carried on, e.g., UEInformationResponse or UEAssistanceInformation.

According to embodiments of the second solution, indication of QoE reporting policy is provided in a QoE resume indication.

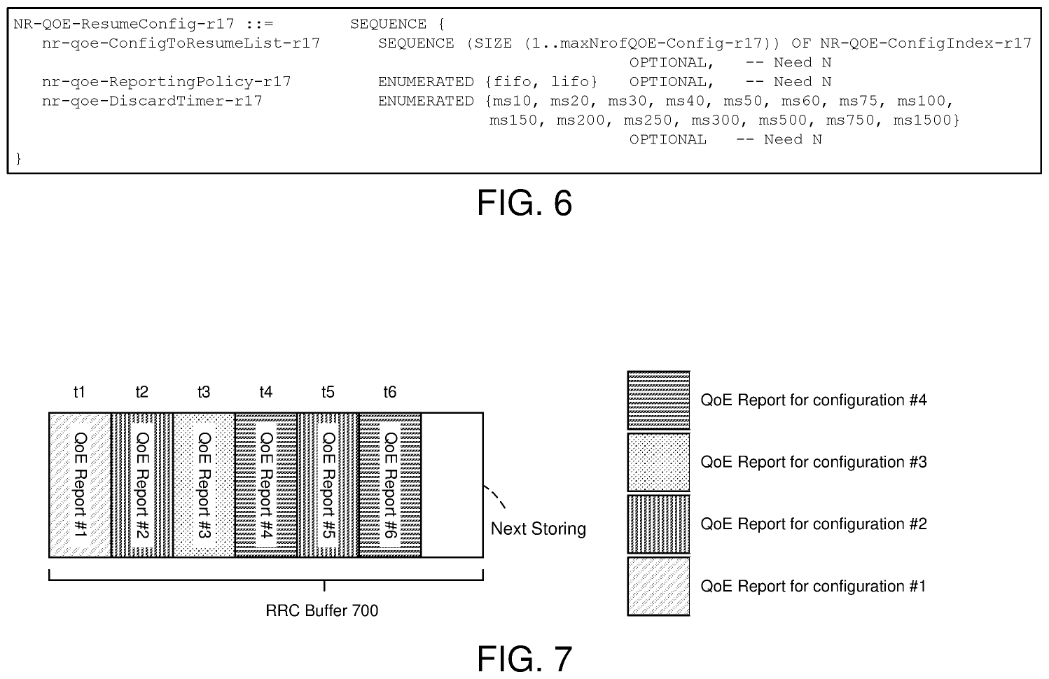

FIG. 6 depicts one embodiment of ASN.1 structure for an RRC resume indication. If RAN congestion is relieved, then the network (i.e., RAN node 210) sends the QoE resume indication to the UE 205 to resume sending QoE reports. The QoE resume indication contains one or more of the following parameters:

The parameter “nr-qoe-ConfigToResumeList-r17” indicates the list of configured QoE measurements for which QoE reporting shall be resumed. If the parameter is absent, then it indicates the UE to resume QoE reporting for all configured QoE measurements.

The parameter “nr-qoe-ReportingPolicy-r17” indicates the policy to apply for QoE reporting. Value “fifo” stands for “first-in first-out,” i.e., the UE shall start processing with the oldest QoE report. Value “lifo” stands for “last-in first-out,” i.e., the UE shall start processing with the most recent QoE report. If the parameter nr-qoe-ReportingPolicy-r17 is not present, then it is left to UE implementation how to process the QoE reports.

The parameter “nr-qoe-DiscardTimer-r17” indicates the maximum buffering time of a QoE report in the RRC buffer after transmitting the QoE report to lower layers (i.e., L2) over SRB4. Value ‘ms10’ corresponds to 10 ms, value ‘ms20’ corresponds to 20 ms and so on. In one implementation, the new timer applies commonly to all QoE reports, i.e., there are multiple instances of the timer, and each instance of the timer is associated with a QoE report. If a QoE report is sent per MeasurementReportAppLayer message to lower layers, then the nr-goe-DiscardTimer-r17 is started for the associated QoE report.

When the nr-qoe-DiscardTimer-r17 expires for a QoE report, or the successful delivery of a QoE report is confirmed by lower layers, the UE 205 shall discard the QoE report from the RRC buffer. If the timer for a QoE report expires, then the RRC sublayer sends to lower layers (Packet Data Convergence Protocol (“PDCP”) or Radio Link Control (“RLC”)) a notification to discard the corresponding PDCP or RLC packets from the transmission buffers.

In another implementation, the network may configure the parameter “nr-goe-DiscardTimer-r17” specifically to a QoE measurement configuration depending on the service type. For instance, for service types such as VR for which large QoE reports are expected to be created the network may want to configure larger timer values. Furthermore, if the nr-goe-DiscardTimer-r17 is present then the network does not configure the PDCP discard timer for SRB4. Likewise, if the nr-qoe-DiscardTimer-r17 is not present then the network configures the PDCP discard timer for SRB4.

The QoE resume indication can be sent by the network either on a new RRC message or existing RRC message such as RRCReconfiguration.

FIG. 7 depicts an example of the storage of QoE reports in an RRC buffer 700, according to embodiments of the disclosure. Here, the RRC buffer 700 is depicted as comprising six QoE reports (number #1 to #6). The first QoE Report #1 corresponds to a first QoE measurement configuration (e.g., for streaming services), the QoE Report #2 and QoE Report #5 correspond to a second QoE measurement configuration (e.g., for MTSI), the QoE Report #3 corresponds to a third QoE measurement configuration (e.g., for VR services), and the QoE Report #4 and QoE Report #6 correspond to a fourth QoE measurement configuration (e.g., for MBS).

Additionally, the first arriving QoE report (depicted as QoE Report #1) is assumed to have arrived at time ‘t1’, the second arriving QoE report (depicted as QoE Report #2) is assumed to have arrived at time ‘t2’, the third arriving QoE report (depicted as QoE Report #3) is assumed to have arrived at time ‘t3’, the fourth arriving QoE report (depicted as QoE Report #4) is assumed to have arrived at time ‘t4’, the fifth arriving QoE report (depicted as QoE Report #5) is assumed to have arrived at time ‘t5’, and the sixth arriving QoE report (depicted as QoE Report #6) is assumed to have arrived at time ‘t6’.

According to embodiments of the third solution, rules are provided for creating and transmitting QoE reports in the MeasurementReportAppLayer message.

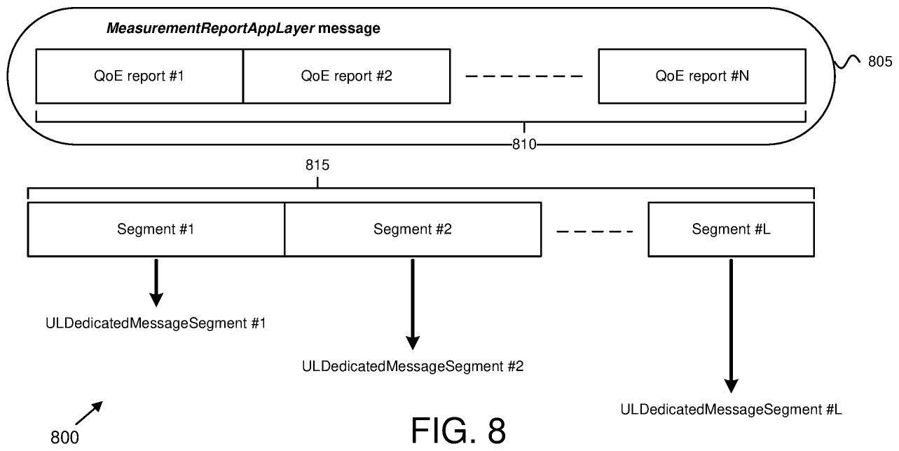

FIG. 8 depicts one embodiment 800 of creating and transmitting multiple QoE reports in the MeasurementReportAppLayer message 805. According to one rule or set of rules, QoE reports shall be transmitted in event-triggered manner, as follows:

In RAN congestion case: In accordance with the QoE resume indication received from the network (see also FIG. 6), the UE 205 creates and transmits stored QoE reports as follows: All concerned QoE reports 810 are concatenated and encapsulated into the MeasurementReportAppLayer message 805. The UE 205 determines the resulting size of the MeasurementReportAppLayer message 805. If the size of the MeasurementReportAppLayer message 805 is larger than the maximum size of an RRC message of 9000 bytes, then the UE 205 performs RRC message segmentation 815. The UE 205 ensures that the size of each segment is less than or equal to the RRC message size limit. Each segment is then included in the existing ULDedicatedMessageSegment message and sent to lower layers. In the depicted embodiment, N QoE reports are encapsulated, then segmented into L ULDedicatedMessageSegment messages.

In normal operation mode (non-RAN congestion case): the UE 205 transfers a QoE report to the network whenever the UE AS layer receives a QoE report from the UE Application Layer. If the UE AS layer receives a single QoE report from UE application layer at a time, then this QoE report will be transmitted in a single MeasurementReportAppLayer message 805. However, if the UE AS layer receives multiple QoE reports from the UE application layer at the same time, then these multiple QoE reports will be transmitted according to the RAN congestion case, as described above.

Beneficially, the proposed solutions may allow the UE 205 to transmit multiple QoE reports in a single MeasurementReportAppLayer message 805 which is more efficient compared to transmitting a single QoE report in a single message. The proposed solutions allow the network to selectively control the transmission of stored QoE reports which were created and stored during RAN overload. Depending on how long the RAN overload situation may take, this is more efficient compared to allowing the transmission of all QoE reports. Some further embodiments of the proposed solutions are described below.

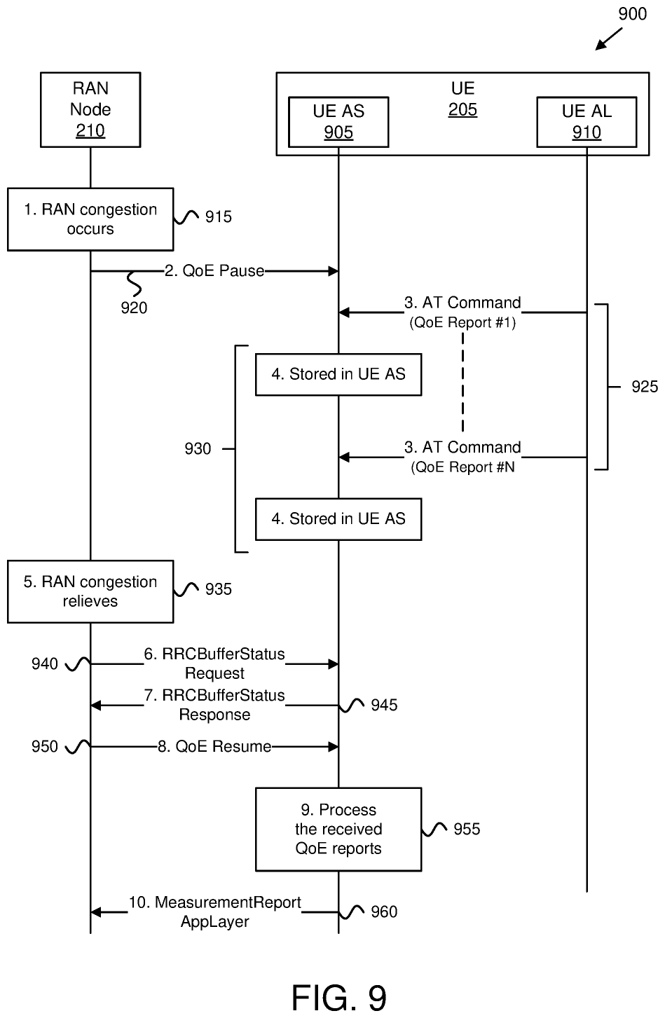

FIG. 9 depicts a procedure 900 for QoE report handling at QoE pause, according to embodiments of the disclosure. The procedure 900 involves the UE 205—comprising a UE AS layer (depicted as “UE AS”) 905 and a UE Application Layer (depicted as “UE AL”) 910. In the procedure 900, the QoE reports which are created and sent by UE Application Layer 910 during QoE pause are stored in UE AS layer.

As a prerequisite, the UE 205 receives a QMC configuration from the RAN node 210 (not depicted in FIG. 9). As an example of this embodiment, it is assumed that the UE 205 in RRC_CONNECTED state has been configured to collect QoE measurements for streaming (configuration #1), MTSI (configuration #2), VR (configuration #3) and MBS (configuration #4).

At Step 1, the RAN node 210 determines that RAN congestion has occurred, e.g., due to high traffic load in the cell served by the RAN node 210 (see block 915).

At Step 2, in order not to further increase the traffic load in the cell, the RAN node 210 sends to the UE 205 (and other UEs as well) a QoE Pause indication to pause the QoE reporting for all configured QoE measurements, e.g., responsive to detecting the RAN congestion condition (see messaging 920). As depicted, the QoE Pause indication is received at the UE AS layer 905.

At Step 3, during the QoE pause phase, the UE Application Layer 910—unaware of the RAN congestion—continues with QMC and sends a series of AT commands to the UE AS layer 905, each AT command message containing a QoE Report (see messaging 925). In the depicted example, the UE Application Layer 910 forwards N QoE reports to the UE AS layer 905.

At Step 4, the UE AS layer 905 stores each received QoE report, e.g., in an RRC buffer (see block 930). As an example, it is assumed that the RAN congestion situation lasts for one hour and that during that time, the UE AS layer 905 receives six QoE reports from UE Application Layer 910 and stores them in its RRC buffer. Referring to FIG. 7, the following sizes of the stored QoE reports are assumed in this example: QoE report #1=2 kBytes; QoE report #2=1 kByte; QoE report #3=18 kBytes; QoE report #4=2 kBytes; QoE report #5=1 kByte; and QoE report #6=2 kBytes (in total 26 kBytes).

Returning to FIG. 9, at Step 5, the RAN node 210 determines that the RAN congestion is relieved (see block 935).

At Step 6, in order to avoid RAN congestion due to transfer of potentially large volume of stored QoE reports the RAN node 210 sends to the UE 205 (i.e., to the UE AS layer 905) the RRCBufferStatusRequest message (see messaging 940). Referring to FIG. 4, the RAN node 210 may request the size of all stored QoE reports by setting the parameter “measurementReportReqAll-r17” in the RRCBufferStatusRequest message 400.

Returning to FIG. 9, at Step 7, the UE AS layer 905 sends to the RAN node 210 an RRCBufferStatusResponse message indicating the size of all stored QoE reports (see messaging 945). Referring to FIG. 5, the UE AS layer 905 may transfer the size of all stored QoE reports to the RAN node 210 by setting the parameter “measurementReportAll-r17” to the enumerated value “kB32” (i.e., 32 kBytes) in the RRCBufferStatusResponse message 500, as this is the smallest enumerated value that exceeds the actual RRC buffer size of 26 kBytes.

Returning to FIG. 9, at Step 8, the RAN node 210 sends to the UE 205 (i.e., the UE AS layer 905) the QoE resume indication requesting the UE 205 to resume the QoE measurement reporting (see messaging 950). Referring to FIG. 6, the RAN node 210 may request the UE to resume QoE reporting for a subset of the configured QoE measurement configurations, e.g., for the QoE measurement configuration #1 (e.g., streaming services), #2 (e.g., MTSI), and #4 (e.g., MBS), using the parameter “nr-qoe-ConfigToResumeList.” As an example, it is assumed that the parameter “nr-qoe-ReportingPolicy-r17” is set to “fifo” (first-in, first-out) and the parameter “nr-qoe-DiscardTimer-r17” is set to 50 ms.

At Step 9, in accordance with the received QoE resume indication the UE AS layer 905 processes the stored QoE reports (see block 955). According to the above example, the UE AS layer 905 creates a MeasurementReportAppLayer message which contains the QoE reports #1, #2, #4, #5 and #6 (following first-in, first-out order). However, because the resulting size of the MeasurementReportAppLayer message is smaller than the RRC message size limit of 9000 bytes, no segmentation of the MeasurementReportAppLayer message is needed. Note that according to FIG. 7 the QoE report #3 corresponds to QoE measurement configuration #3, which is not listed in the parameter “nr-qoe-ConfigToResumeList.”

At Step 10, the UE AS layer 905 sends the MeasurementReportAppLayer message to the RAN node 210 (see messaging 960). When the successful delivery of the QoE reports within the nr-qoe-DiscardTimer-r17 value is confirmed by lower layers, the UE AS layer 905 discards the QoE reports #1, #2, #4, #5 and #6 from the RRC buffer.

In an alternative embodiment of the procedure 900, at Step 8, the QoE resume indication sent by the RAN node 210 (see messaging 950) may request the UE 205 to resume the QoE measurement reporting for the QoE measurement configuration #3 (VR) and #4 (MBS). For example, the parameter “nr-qoe-ReportingPolicy-r17” may be set to “lifo” (last-in, first-out) and the parameter “nr-qoe-DiscardTimer-r17” is set to 50 ms.

At alternative Step 9, in accordance with the received QoE resume indication the UE 205 processes the stored QoE reports. That means the UE 205 creates a MeasurementReportAppLayer message which contains the QoE reports #6, #4 and #3 (following last-in, first-out order). Since the resulting size of the MeasurementReportAppLayer message is 22 kBytes and thus larger than the RRC message size limit of 9000 bytes, the MeasurementReportAppLayer message needs to be segmented into 3 segments.

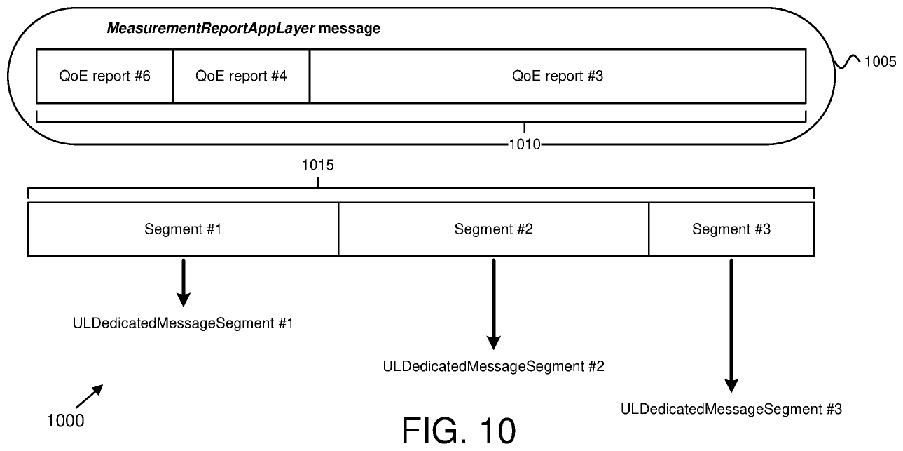

Step 10: The UE sends the QoE reports #6, #4 and #3 as segments in the ULDedicatedMessageSegment message to the gNB, as shown in FIG. 10. When the successful delivery of the QoE reports within the nr-qoe-DiscardTimer-r17 value is confirmed by lower layers, the UE discards the QoE reports #6, #4 and #3 from the RRC buffer.

FIG. 10 depicts one embodiment 1000 of a MeasurementReportAppLayer message 1005 segmented into a plurality of ULDedicatedMessageSegment messages 1015, according to embodiments of the disclosure. Here, the MeasurementReportAppLayer message 1005 contains the QoE report #6 (2 kBytes), the QoE report #4 (2 kBytes), and the QoE report #3 (18 kBytes), for a total size of 22 kBytes. All concerned QoE reports 1010 are concatenated and encapsulated into the MeasurementReportAppLayer message 1005. Because the size of the MeasurementReportAppLayer message 1005 is larger than the maximum size of an RRC message of 9000 bytes, the UE 205 performs RRC message segmentation to segment the encapsulated QoE reports into three ULDedicatedMessageSegment messages 1015. The UE 205 ensures that the size of each segment is less than or equal to the RRC message size limit.

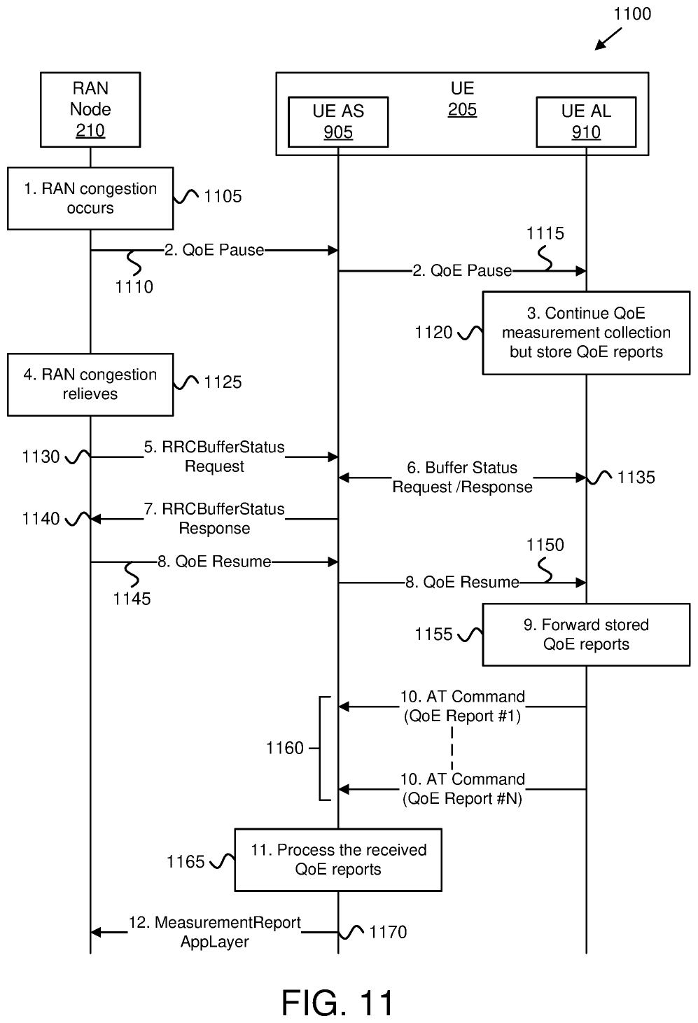

FIG. 11 depicts a further procedure 1100 for QoE report handling at QoE pause, according to embodiments of the disclosure. The procedure 1100 involves the UE 205 —comprising the UE AS layer (depicted as “UE AS”) 905 and the UE Application Layer (depicted as “UE AL”) 910. In the procedure 1100, the QoE reports are stored at the UE Application Layer 910.

At Step 1, the RAN node 210 determines that RAN congestion has occurred (see block 1105).

At Step 2, the RAN node 210 sends a QoE Pause indication to the UE AS layer 905, which forwards the QoE Pause indication to the UE Application Layer 910 (see messaging 1110 and 1115).

At Step 3, the UE Application Layer 910 continues QMC, but stores the QoE reports at the UE Application Layer 910 (see block 1120).

At Step 4, the RAN node 210 determines that the RAN congestion is relieved (see block 1125).

At Step 5, in order to avoid RAN congestion due to transfer of potentially large volume of stored QoE reports the RAN node 210 requests the size of all stored QoE reports from the UE 205 (i.e., the UE Application Layer 910), e.g., using the RRCBufferStatusRequest message (see messaging 1130).

At Step 6, the UE AS layer 905 retrieves the size of all stored QoE reports from the UE Application Layer 910 (see messaging 1135).

At Step 7, the UE AS layer 905 indicates the size of all stored QoE reports to the RAN node 210, e.g., in the RRCBufferStatusResponse message (see messaging 1140).

At Step 8, the RAN node 210 sends a QoE Resume indication to the UE AS layer 905, which forwards the QoE Resume indication to the UE Application Layer 910 (see messaging 1145 and 1150).

At Step 9, the UE Application Layer 910 determines to forward the stored QoE reports (see block 1155).

At Step 10, the UE Application Layer 910 sends a series of AT commands to the UE AS layer 905, each AT command message containing a QoE Report (see messaging 1160). In the depicted example, the UE Application Layer 910 forwards N QoE reports.

At Step 11, the UE AS layer 905 processes the received QoE reports (see block 1165).

At Step 12, the UE AS layer 905 sends a MeasurementReportAppLayer message to the RAN node 210 (see messaging 1170). Exemplary structure and segmentation of the MeasurementReportAppLayer message is described above with reference to FIG. 8.

A third embodiment of QoE reporting, in normal operation mode, is presented. In an example of this embodiment, the UE AS layer 905 receives 6 QoE reports from UE Application Layer 910 at following time instances:
t1: QoE report #1: 2 kBytes
t2: QoE report #2: 1 kByte
t3: QoE report #3: 18 kBytes; QoE report #4: 2 kBytes; QoE report #5: 1 kByte
t4: QoE report #6: 2 kBytes

The QoE reports #1, #2 and #6 are transmitted each in a single MeasurementReportAppLayer message since its size is always smaller than the RRC message size limit of 9000 bytes.

For the QoE reports #3, #4 and #5 the UE concatenates the QoE reports and encapsulates the concatenated QoE reports into a MeasurementReportAppLayer message. Since the resulting size of the MeasurementReportAppLayer message is 21 kBytes and thus larger than the RRC message size limit of 9000 bytes, the MeasurementReportAppLayer message is segmented into 3 segments. The UE sends the QoE reports #3, #4 and #5 as segments in the ULDedicatedMessageSegment message to the gNB.

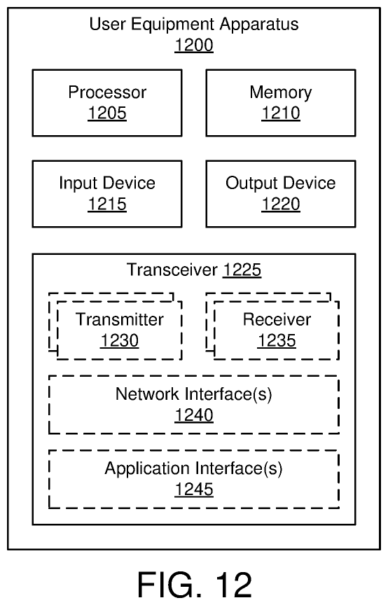

FIG. 12 depicts a user equipment apparatus 1200 that may be used for QoE measurement reporting control, according to embodiments of the disclosure. In various embodiments, the user equipment apparatus 1200 is used to implement one or more of the solutions described above. The user equipment apparatus 1200 may be one embodiment of a user endpoint, such as the remote unit 105 and/or the UE 205, as described above. Furthermore, the user equipment apparatus 1200 may include a processor 1205, a memory 1210, an input device 1215, an output device 1220, and a transceiver 1225.

In some embodiments, the input device 1215 and the output device 1220 are combined into a single device, such as a touchscreen. In certain embodiments, the user equipment apparatus 1200 may not include any input device 1215 and/or output device 1220. In various embodiments, the user equipment apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. In some embodiments, the transceiver 1225 communicates with one or more cells (or wireless coverage areas) supported by one or more base units 121. In various embodiments, the transceiver 1225 is operable on unlicensed spectrum. Moreover, the transceiver 1225 may include multiple UE panels supporting one or more beams. Additionally, the transceiver 1225 may support at least one network interface 1240 and/or application interface 1245. The application interface(s) 1245 may support one or more APIs. The network interface(s) 1240 may support 3GPP reference points, such as Uu, N1, PC5, etc. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225.

In various embodiments, the processor 1205 controls the user equipment apparatus 1200 to implement the above-described UE behaviors. In certain embodiments, the processor 1205 may include an application processor (also known as “main processor”) which manages application-domain and operating system (“OS”) functions and a baseband processor (also known as “baseband radio processor”) which manages radio functions.

In various embodiments, via the transceiver 1225, the processor 1205 receives, from a network node, a first message requesting a size of stored QoE measurement reports in the RRC buffer (i.e., an element of the processor 1205, the memory 1210, the transceiver 1225, and/or the network interface 1240). In some embodiments, the first message is received while the apparatus is in a UE state in which QoE measurement reporting is not allowed. In some embodiments, the first message includes a request to transfer the size of all stored QoE measurement reports. In some embodiments, the first message includes a request to transfer the size of the stored QoE measurement reports for a list of configured QoE measurements.

The processor 1205 determines the size of the stored QoE measurement reports in response to the first message and directs the transceiver 1225 to transmit a second message to the network node. Here, the second message includes the size of stored QoE measurement reports in the RRC buffer. In some embodiments, the second message is sent while the apparatus is in the UE state in which QoE measurement reporting is not allowed. In some embodiments, the second message includes the size of all stored QoE measurement reports. In some embodiments, the second message includes the size of the stored QoE measurement reports for a list of configured QoE measurements.

Via the transceiver 1225, the processor 1205 receives, from the network node, a third message including a configuration to enable resumption of QoE measurement reporting. In some embodiments, the third message is received while the apparatus is in a UE state in which QoE measurement reporting is not allowed.

In some embodiments, the configuration to enable resumption of QoE measurement reporting includes a start indication for QoE measurement report processing, where the start indication includes an indication to start the processing with the oldest QoE measurement report or an indication to start the processing with the most recent QoE measurement report. In certain embodiments, the configuration to enable resumption of QoE measurement reporting further includes an indication of maximum buffering time of the stored QoE measurement reports in the RRC buffer when the stored QoE measurement reports have been sent to lower layers for transmission.

The processor 1205 directs the transceiver 1225 to transmit at least one fourth message to the network node. Here, each of the at least one fourth message includes at least one QoE measurement report. In some embodiments, the fourth message includes one or multiple complete QoE measurement reports. In certain embodiments, the fourth message further includes one or multiple segments of QoE measurement reports.

The memory 1210, in one embodiment, is a computer readable storage medium. In some embodiments, the memory 1210 includes volatile computer storage media. For example, the memory 1210 may include a RAM, including dynamic RAM (“DRAM”), synchronous dynamic RAM (“SDRAM”), and/or static RAM (“SRAM”). In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to QoE measurement reporting control. For example, the memory 1210 may store parameters, configurations, and the like as described above. In certain embodiments, the memory 1210 also stores program code and related data, such as an operating system or other controller algorithms operating on the user equipment apparatus 1200.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1220 may include a wearable display separate from, but communicatively coupled to, the rest of the user equipment apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 communicates with one or more network functions of a mobile communication network via one or more access networks. The transceiver 1225 operates under the control of the processor 1205 to transmit messages, data, and other signals and also to receive messages, data, and other signals. For example, the processor 1205 may selectively activate the transceiver 1225 (or portions thereof) at particular times in order to send and receive messages.

The transceiver 1225 includes at least one transmitter 1230 and at least one receiver 1235. One or more transmitters 1230 may be used to provide UL communication signals to a base unit 121, such as the UL transmissions described herein. Similarly, one or more receivers 1235 may be used to receive DL communication signals from the base unit 121, as described herein. Although only one transmitter 1230 and one receiver 1235 are illustrated, the user equipment apparatus 1200 may have any suitable number of transmitters 1230 and receivers 1235. Further, the transmitter(s) 1230 and the receiver(s) 1235 may be any suitable type of transmitters and receivers. In one embodiment, the transceiver 1225 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 1225, transmitters 1230, and receivers 1235 may be implemented as physically separate components that access a shared hardware resource and/or software resource, such as for example, the network interface 1240.

In various embodiments, one or more transmitters 1230 and/or one or more receivers 1235 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1230 and/or one or more receivers 1235 may be implemented and/or integrated into a multi-chip module. In some embodiments, other components such as the network interface 1240 or other hardware components/circuits may be integrated with any number of transmitters 1230 and/or receivers 1235 into a single chip. In such embodiment, the transmitters 1230 and receivers 1235 may be logically configured as a transceiver 1225 that uses one or more common control signals or as modular transmitters 1230 and receivers 1235 implemented in the same hardware chip or in a multi-chip module.

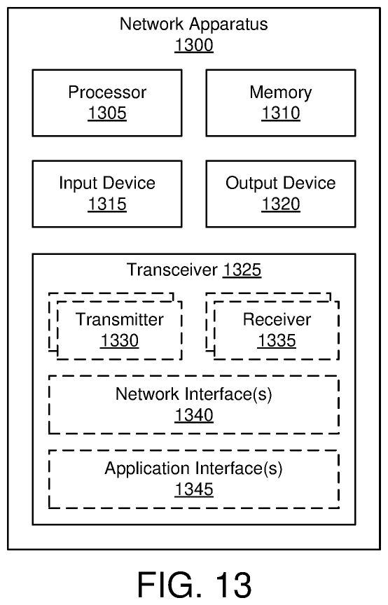

FIG. 13 depicts a network apparatus 1300 that may be used for QoE measurement reporting control, according to embodiments of the disclosure. In one embodiment, the network apparatus 1300 may be one implementation of a network endpoint, such as the base unit 121 and/or RAN node 210, as described above. Furthermore, the network apparatus 1300 may include a processor 1305, a memory 1310, an input device 1315, an output device 1320, and a transceiver 1325.

In some embodiments, the input device 1315 and the output device 1320 are combined into a single device, such as a touchscreen. In certain embodiments, the network apparatus 1300 may not include any input device 1315 and/or output device 1320. In various embodiments, the network apparatus 1300 may include one or more of: the processor 1305, the memory 1310, and the transceiver 1325, and may not include the input device 1315 and/or the output device 1320.

As depicted, the transceiver 1325 includes at least one transmitter 1330 and at least one receiver 1335. Here, the transceiver 1325 communicates with one or more remote units 105. Additionally, the transceiver 1325 may support at least one network interface 1340 and/or application interface 1345. The application interface(s) 1345 may support one or more APIs. The network interface(s) 1340 may support 3GPP reference points, such as Uu, N1, N2 and N3. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a CPU, a GPU, an auxiliary processing unit, a FPGA, or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325.

In various embodiments, the network apparatus 1300 is a RAN node (e.g., gNB) that communicates with one or more UEs, as described herein. In such embodiments, the processor 1305 controls the network apparatus 1300 to perform the above-described RAN behaviors. When operating as a RAN node, the processor 1305 may include an application processor (also known as “main processor”) which manages application-domain and operating system (“OS”) functions and a baseband processor (also known as “baseband radio processor”) which manages radio functions.

In various embodiments, via the transceiver 1325, the processor 1305 transmits, to a communication device, a first message requesting a size of stored QoE measurement reports in an RRC buffer of the communication device. In some embodiments, the first message is received while the communication device is in a UE state in which QoE measurement reporting is not allowed. In some embodiments, the first message includes a request to transfer the size of all stored QoE measurement reports. In some embodiments, the first message includes a request to transfer the size of the stored QoE measurement reports for a list of configured QoE measurements.

Via the transceiver 1325, the processor 1305 receives a second message from a communication device. Here, the second message includes the size of the stored QoE measurement reports. In some embodiments, the second message is sent while the communication device is in the UE state in which QoE measurement reporting is not allowed. In some embodiments, the second message includes the size of all stored QoE measurement reports. In some embodiments, the second message includes the size of the stored QoE measurement reports for a list of configured QoE measurements.

The processor 1305 determines, using the second message, a configuration to enable resumption of QoE measurement reporting at the communication device. In some embodiments, the configuration to enable resumption of QoE measurement reporting includes a start indication for QoE measurement report processing, the start indication including an indication to start the processing with the oldest QoE measurement report or an indication to start the processing with the most recent QoE measurement report.

In certain embodiments, the configuration to enable resumption of QoE measurement reporting further includes an indication of maximum buffering time of the stored QoE measurement reports in the RRC buffer when the stored QoE measurement reports have been sent to lower layers for transmission.

The processor 1305 directs the transmitter 1330 to transmit a third message to the communication device, where the third message includes the configuration to enable resumption of QoE measurement reporting. In some embodiments, the third message is received while the communication device is in a UE state in which QoE measurement reporting is not allowed. Via the transceiver 1325, the processor 1305 receives at least one fourth message from the communication device, each of the at least fourth message including at least one QoE measurement report.

The memory 1310, in one embodiment, is a computer readable storage medium. In some embodiments, the memory 1310 includes volatile computer storage media. For example, the memory 1310 may include a RAM, including DRAM, SDRAM, and/or SRAM. In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data related to QoE measurement reporting control. For example, the memory 1310 may store parameters, configurations, and the like, as described above. In certain embodiments, the memory 1310 also stores program code and related data, such as an operating system or other controller algorithms operating on the network apparatus 1300.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, is designed to output visual, audible, and/or haptic signals. In some embodiments, the output device 1320 includes an electronically controllable display or display device capable of outputting visual data to a user. For example, the output device 1320 may include, but is not limited to, an LCD display, an LED display, an OLED display, a projector, or similar display device capable of outputting images, text, or the like to a user. As another, non-limiting, example, the output device 1320 may include a wearable display separate from, but communicatively coupled to, the rest of the network apparatus 1300, such as a smart watch, smart glasses, a heads-up display, or the like. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all or portions of the output device 1320 may be integrated with the input device 1315. For example, the input device 1315 and output device 1320 may form a touchscreen or similar touch-sensitive display. In other embodiments, the output device 1320 may be located near the input device 1315.

The transceiver 1325 includes at least one transmitter 1330 and at least one receiver 1335. One or more transmitters 1330 may be used to communicate with the UE, as described herein. Similarly, one or more receivers 1335 may be used to communicate with network functions in the PLMN and/or RAN, as described herein. Although only one transmitter 1330 and one receiver 1335 are illustrated, the network apparatus 1300 may have any suitable number of transmitters 1330 and receivers 1335. Further, the transmitter(s) 1330 and the receiver(s) 1335 may be any suitable type of transmitters and receivers.

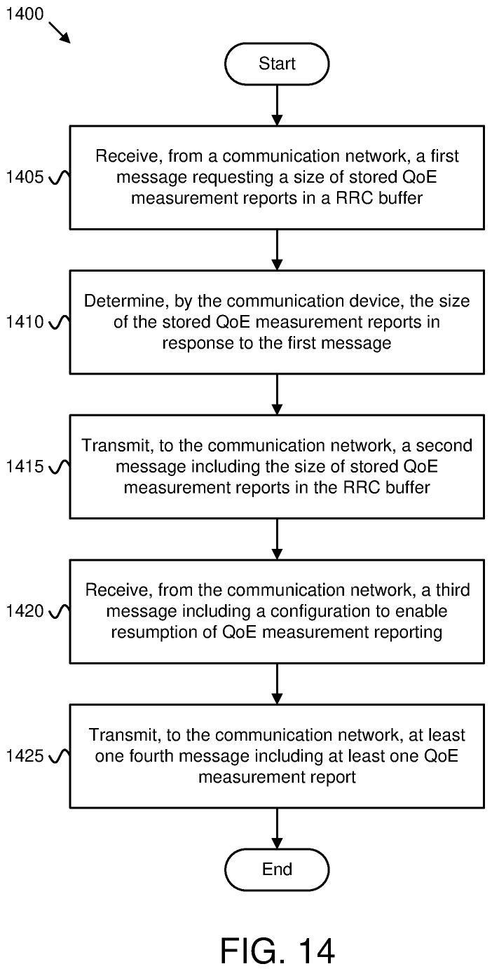

FIG. 14 depicts one embodiment of a method 1400 for QoE measurement reporting control, according to embodiments of the disclosure. In various embodiments, the method 1400 is performed by a communication device, such as a remote unit 105, a UE 205, and/or the user equipment apparatus 1200, described above. In some embodiments, the method 1400 is performed by a processor, such as a microcontroller, a microprocessor, a CPU, a GPU, an auxiliary processing unit, a FPGA, or the like.

The method 1400 includes receiving 1405, from a communication network, a first message requesting a size of stored QoE measurement reports in an RRC buffer. The method 1400 includes determining 1410, by the communication device, the size of the stored QoE measurement reports in response to the first message. The method 1400 includes transmitting 1415, to the communication network, a second message including the size of stored QoE measurement reports in the RRC buffer. The method 1400 includes receiving 1420, from the communication network, a third message including a configuration to enable resumption of QoE measurement reporting. The method 1400 includes transmitting 1425, to the communication network, at least one fourth message including at least one QoE measurement report. The method 1400 ends.

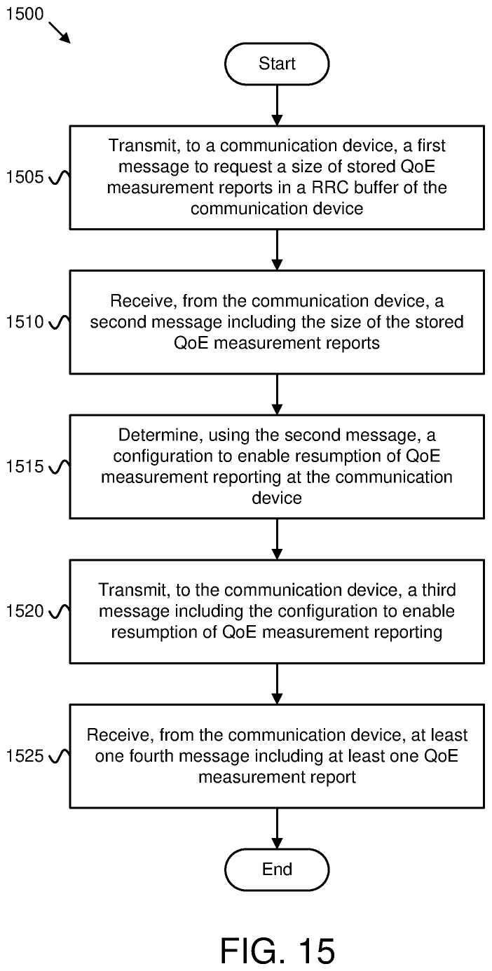

FIG. 15 depicts one embodiment of a method 1500 for QoE measurement reporting control, according to embodiments of the disclosure. In various embodiments, the method 1500 is performed by a network device, such as the base unit 121, the RAN node 210, and/or the network apparatus 1300, as described above. In some embodiments, the method 1500 is performed by a processor, such as a microcontroller, a microprocessor, a CPU, a GPU, an auxiliary processing unit, a FPGA, or the like.

The method 1500 includes transmitting 1505 a first message to a communication device to request a size of stored QoE measurement reports in an RRC buffer of the communication device. The method 1500 includes receiving 1510, from a communication device, a second message including the size of the stored QoE measurement reports. The method 1500 includes determining 1515, using the second message, a configuration to enable resumption of QoE measurement reporting at the communication device. The method 1500 includes transmitting 1520, to the communication device, a third message including the configuration to enable resumption of QoE measurement reporting. The method 1500 includes receiving 1525, from the communication device, at least one fourth message including at least one QoE measurement report. The method 1500 ends.

Disclosed herein is a first apparatus for QoE measurement reporting control, according to embodiments of the disclosure. The first apparatus may be implemented by a communication device, such as a remote unit 105, a UE 205, and/or the user equipment apparatus 1200, described above. The first apparatus includes a transceiver and a processor coupled to an RRC buffer, the processor configured to cause the apparatus to: A) receive, from a communication network, a first message requesting a size of stored QoE measurement reports in the RRC buffer; B) determine the size of the stored QoE measurement reports in response to the first message; C) transmit, to the communication network, a second message including the size of stored QoE measurement reports in the RRC buffer; D) receive, from the communication network, a third message including a configuration to enable resumption of QoE measurement reporting; and E) transmit, to the communication network, at least one fourth message including at least one QoE measurement report.

In some embodiments, the first message and the third message are received while the first apparatus is in a UE state in which QoE measurement reporting is not allowed, wherein the second message is sent while the first apparatus is in the UE state in which QoE measurement reporting is not allowed.

In some embodiments, the first message includes a request to transfer the size of all stored QoE measurement reports, wherein the second message includes the size of all stored QoE measurement reports.

In some embodiments, the first message includes a request to transfer the size of the stored QoE measurement reports for a list of configured QoE measurements, wherein the second message includes the size of the stored QoE measurement reports for a list of configured QoE measurements.

In some embodiments, the configuration to enable resumption of QoE measurement reporting includes a start indication for QoE measurement report processing, the start indication including an indication to start the processing with the oldest QoE measurement report or an indication to start the processing with the most recent QoE measurement report.

In certain embodiments, the configuration to enable resumption of QoE measurement reporting further includes an indication of maximum buffering time of the stored QoE measurement reports in the RRC buffer when the stored QoE measurement reports have been sent to lower layers for transmission.

In some embodiments, the fourth message includes one or multiple complete QoE measurement reports. In certain embodiments, the fourth message further includes one or multiple segments of QoE measurement reports.

Disclosed herein is a first method for QoE measurement reporting control, according to embodiments of the disclosure. The first method may be performed by a communication device, such as a remote unit 105, a UE 205, and/or the user equipment apparatus 1200, described above. The first method includes receiving, from a communication network, a first message requesting a size of stored QoE measurement reports in an RRC buffer. The first method includes determining, by the communication device, the size of the stored QoE measurement reports in response to the first message and transmitting, to the communication network, a second message including the size of stored QoE measurement reports in the RRC buffer. The first method includes receiving, from the communication network, a third message including a configuration to enable resumption of QoE measurement reporting and transmitting, to the communication network, at least one fourth message including at least one QoE measurement report.

In some embodiments, the first message and the third message are received while the communication device is in a UE state in which QoE measurement reporting is not allowed, wherein the second message is sent while the communication device is in the UE state in which QoE measurement reporting is not allowed.

In some embodiments, the first message includes a request to transfer the size of all stored QoE measurement reports, wherein the second message includes the size of all stored QoE measurement reports.

In some embodiments, the first message includes a request to transfer the size of the stored QoE measurement reports for a list of configured QoE measurements, wherein the second message includes the size of the stored QoE measurement reports for a list of configured QoE measurements.

In some embodiments, the configuration to enable resumption of QoE measurement reporting includes a start indication for QoE measurement report processing, the start indication including an indication to start the processing with the oldest QoE measurement report or an indication to start the processing with the most recent QoE measurement report.

In certain embodiments, the configuration to enable resumption of QoE measurement reporting further includes an indication of maximum buffering time of the stored QoE measurement reports in the RRC buffer when the stored QoE measurement reports have been sent to lower layers for transmission.

In some embodiments, the fourth message includes one or multiple complete QoE measurement reports. In certain embodiments, the fourth message further includes one or multiple segments of QoE measurement reports.

Disclosed herein is a second apparatus for QoE measurement reporting control, according to embodiments of the disclosure. The second apparatus may be implemented by a network device, such as the base unit 121, the RAN node 210, and/or the network apparatus 1300, as described above. The second apparatus includes a processor coupled to a transceiver, the transceiver configured to communicate with a UE and the processor configured to cause the apparatus to: A) transmit, to a communication device, a first message requesting a size of stored QoE measurement reports in an RRC buffer of the communication device; B) receive, from the communication device, a second message including the size of the stored QoE measurement reports; C) determine, using the second message, a configuration to enable resumption of QoE measurement reporting at the communication device; D) transmit, to the communication device, a third message including the configuration to enable resumption of QoE measurement reporting; and E) receive, from the communication device, at least one fourth message including at least one QoE measurement report.

In some embodiments, the first message and the third message are received while the communication device is in a UE state in which QoE measurement reporting is not allowed, wherein the second message is sent while the communication device is in the UE state in which QoE measurement reporting is not allowed.

In some embodiments, the first message includes a request to transfer the size of all stored QoE measurement reports, wherein the second message includes the size of all stored QoE measurement reports.

In some embodiments, the first message includes a request to transfer the size of the stored QoE measurement reports for a list of configured QoE measurements, wherein the second message includes the size of the stored QoE measurement reports for a list of configured QoE measurements.

In some embodiments, the configuration to enable resumption of QoE measurement reporting includes a start indication for QoE measurement report processing, the start indication including an indication to start the processing with the oldest QoE measurement report or an indication to start the processing with the most recent QoE measurement report.

In certain embodiments, the configuration to enable resumption of QoE measurement reporting further includes an indication of maximum buffering time of the stored QoE measurement reports in the RRC buffer when the stored QoE measurement reports have been sent to lower layers for transmission.

Disclosed herein is a second method for QoE measurement reporting control, according to embodiments of the disclosure. The second method may be performed by a network device, such as the base unit 121, the RAN node 210, and/or the network apparatus 1300, as described above. The second method includes transmitting a first message to a communication device to request a size of stored QoE measurement reports in an RRC buffer of the communication device and receiving, from the communication device, a second message including the size of the stored QoE measurement reports. The second method includes determining, using the second message, a configuration to enable resumption of QoE measurement reporting at the communication device and transmitting, to the communication device, a third message including the configuration to enable resumption of QoE measurement reporting. The second method includes receiving, from the communication device, at least one fourth message including at least one QoE measurement report.

In some embodiments, the first message and the third message are received while the communication device is in a UE state in which QoE measurement reporting is not allowed, wherein the second message is sent while the communication device is in the UE state in which QoE measurement reporting is not allowed.

In some embodiments, the first message includes a request to transfer the size of all stored QoE measurement reports, wherein the second message includes the size of all stored QoE measurement reports.

In some embodiments, the first message includes a request to transfer the size of the stored QoE measurement reports for a list of configured QoE measurements, wherein the second message includes the size of the stored QoE measurement reports for a list of configured QoE measurements.

In some embodiments, the configuration to enable resumption of QoE measurement reporting includes a start indication for QoE measurement report processing, the start indication including an indication to start the processing with the oldest QoE measurement report or an indication to start the processing with the most recent QoE measurement report.

In certain embodiments, the configuration to enable resumption of QoE measurement reporting further includes an indication of maximum buffering time of the stored QoE measurement reports in the RRC buffer when the stored QoE measurement reports have been sent to lower layers for transmission.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) apparatus comprising:
a processor;
a Radio Resource Control (“RRC”) buffer; and
a memory coupled with the processor, the processor configured to cause the apparatus to:
receive, from a communication network, a first message requesting a size of stored Quality of Experience (“QoE”) measurement reports in the RRC buffer;
determine the size of the stored QoE measurement reports in response to the first message;
transmit, to the communication network, a second message comprising the size of stored QoE measurement reports in the RRC buffer;
receive, from the communication network, a third message comprising a configuration to enable resumption of QoE measurement reporting; and
transmit, to the communication network, at least one fourth message comprising at least one QoE measurement report.

2. The apparatus of claim 1, wherein the first message and the third message are received while the apparatus is in a UE state in which QoE measurement reporting is not allowed, wherein the second message is sent while the apparatus is in the UE state in which QoE measurement reporting is not allowed.

3. The apparatus of claim 1, wherein the first message comprises a request to transfer a size of all stored QoE measurement reports, wherein the second message comprises the size of all stored QoE measurement reports.

4. The apparatus of claim 1, wherein the first message comprises a request to transfer the size of the stored QoE measurement reports for a list of configured QoE measurements, wherein the second message comprises the size of the stored QoE measurement reports for a list of configured QoE measurements.

5. The apparatus of claim 1, wherein the configuration to enable resumption of QoE measurement reporting comprises a start indication for QoE measurement report processing, the start indication comprising an indication to start the processing with the oldest QoE measurement report or an indication to start the processing with the most recent QoE measurement report.

6. The apparatus of claim 5, wherein the configuration to enable resumption of QoE measurement reporting further comprises an indication of maximum buffering time of the stored QoE measurement reports in the RRC buffer when the stored QoE measurement reports have been sent to lower layers for transmission.

7. The apparatus of claim 1, wherein the fourth message comprises one or multiple complete QoE measurement reports.

8. The apparatus of claim 7, wherein the fourth message further comprises one or multiple segments of QoE measurement reports.

9. A network apparatus comprising:
a processor; and
a memory coupled to the processor, the processor configured to cause the apparatus to:
transmit, to a communication device, a first message requesting a size of stored Quality of Experience (“QoE”) measurement reports in a radio resource control (“RRC”) buffer of the communication device;
receive, from the communication device, a second message comprising the size of the stored QoE measurement reports;
determine, using the second message, a configuration to enable resumption of QoE measurement reporting at the communication device;
transmit, to the communication device, a third message comprising the configuration to enable resumption of QoE measurement reporting; and
receive, from the communication device, at least one fourth message comprising at least one QoE measurement report.

10. The apparatus of claim 9, wherein the first message and the third message are received while the communication device is in a UE state in which QoE measurement reporting is not allowed, wherein the second message is sent while the communication device is in the UE state in which QoE measurement reporting is not allowed.

11. The apparatus of claim 9, wherein the first message comprises a request to transfer a size of all stored QoE measurement reports, wherein the second message comprises the size of all stored QoE measurement reports.

12. The apparatus of claim 9, wherein the first message comprises a request to transfer the size of the stored QoE measurement reports for a list of configured QoE measurements, wherein the second message comprises the size of the stored QoE measurement reports for a list of configured QoE measurements.

13. The apparatus of claim 9, wherein the configuration to enable resumption of QoE measurement reporting comprises a start indication for QoE measurement report processing, the start indication comprising an indication to start the processing with the oldest QoE measurement report or an indication to start the processing with the most recent QoE measurement report.

14. The apparatus of claim 13, wherein the configuration to enable resumption of QoE measurement reporting further comprises an indication of maximum buffering time of the stored QoE measurement reports in the RRC buffer when the stored QoE measurement reports have been sent to lower layers for transmission.

15. A method in a communication network, the method comprising:
transmitting a first message from a communication network to a communication device to request a size of stored Quality of Experience (“QoE”) measurement reports in a radio resource control (“RRC”) buffer of the communication device;
receiving, from the communication device, a second message comprising the size of the stored QoE measurement reports;
determining, using the second message, a configuration to enable resumption of QoE measurement reporting at the communication device;
transmitting, to the communication device, a third message comprising the configuration to enable resumption of QoE measurement reporting; and
receiving, from the communication device, at least one fourth message comprising at least one QoE measurement report.
